(19) United States
(12) Patent Application Publication
(10) Pub. No.: US 2026/0105358 A1
(43) Pub. Date: Apr. 16, 2026

(54) Progressively Improving Time-Series Anomaly Detection

(71) Applicant: Bank of America Corporation, Charlotte, NC (US)

(72) Inventors: Maharaj Mukherjee, Poughkeepsie, NY (US); Carl Benda, Charlotte, NC (US); Viraj Shah, Maharashtra (IN); Vijay Yarabolu, Hyderabad (IN); Aditya Krishnanand Chaubey, Maharashtra (IN); Rahul Uniyal, Uttarakhand (IN); Duy Minh Pham, Charlotte, NC (US)

(21) Appl. No.: 18/917,019

(22) Filed: Oct. 16, 2024

(51) Int. Cl. G06N 20/00

(52) U.S. Cl. CPC G06N 20/00

(57) ABSTRACT

Arrangements for anomaly detection are provided. In some aspects, a computing platform may receive data from a plurality of servers. The server data may be analyzed to fit a logarithmic curve to the data. The computing platform may identify an inflection point in the curve and may fit a two-piece linear curve to the logarithmic curve. The computing platform may identify a machine learning algorithm based on the two-piece linear curve and may build a machine learning model based on the machine learning algorithm. Additional server data may be received and may be input to the machine learning model. The computing platform may execute the machine learning model on the additional server data to predict one or more values and/or identify one or more anomalies in data. The computing platform may generate a notification identifying any anomalies and may transmit or send the notification to a user computing device.

### BACKGROUND

Aspects of the disclosure relate to electrical computers, systems, and devices for time-series data anomaly detection.

Conventional machine learning arrangements used to identify anomalies in data have difficulty when seasonality trends impact the data. Further, because each time slot in a time series depends on a previous time slot, and all prior time slots, the interdependencies of the time slots create an algorithm that is exponential in terms of time slots. Accordingly, processing data using this algorithm can be both time and computing resource intensive. Accordingly, it would be advantageous to create an algorithm focused on relevant data occurring closer in time to a current time.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with identifying anomalies in time series data.

In some aspects, a computing platform may receive data from a plurality of servers. The server data may be analyzed to fit a logarithmic curve to the data. In some examples, the computing platform may identify an inflection point in the curve and may fit a two-piece linear curve to the logarithmic curve. The computing platform may identify a machine learning algorithm based on the two-piece linear curve and may build a machine learning model based on the machine learning algorithm.

In some examples, additional server data may be received and may be input to the machine learning model. The computing platform may execute the machine learning model on the additional server data to predict one or more values and/or identify one or more anomalies in data. The computing platform may generate a notification identifying any anomalies and may transmit or send the notification to a user computing device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing anomaly detection functions in accordance with one or more aspects described herein;

FIGS. 2A-2D depict an illustrative event sequence for anomaly detection in accordance with one or more aspects described herein;

FIG. 3 illustrates an illustrative method for anomaly detection according to one or more aspects described herein;

FIG. 4 illustrates one example user interface that may be generated according to one or more aspects described herein;

FIGS. 5A and 5B illustrate example data series in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional time series analysis might have difficulty accounting for seasonality in data. Further, each time slot in a time series depends on a previous time slot, which depends on a previous time slot, and so forth, to create interdependencies that are exponential in terms of time slots. This can lead excessive use of computing resources and may cause delays in processing or analyzing current data.

Accordingly, arrangements described herein provide for improving on autoregressive models by identifying a logarithmic factor corresponding to data close in time to a current time slot. This may account for relevance of the data closer to the current time being increased over more historical data. The logarithmic factor may be approximated using a piece-wise linear curve. For instance, a piece-wise linear curve may be fit to the logarithmic factor in order to approximate the logarithmic factor. An algorithm based on the piece-wise linear curve may be generated and used to build a machine learning model to analyze data and predict or identify anomalies in the data.

These and various other arrangements will be discussed more fully below.

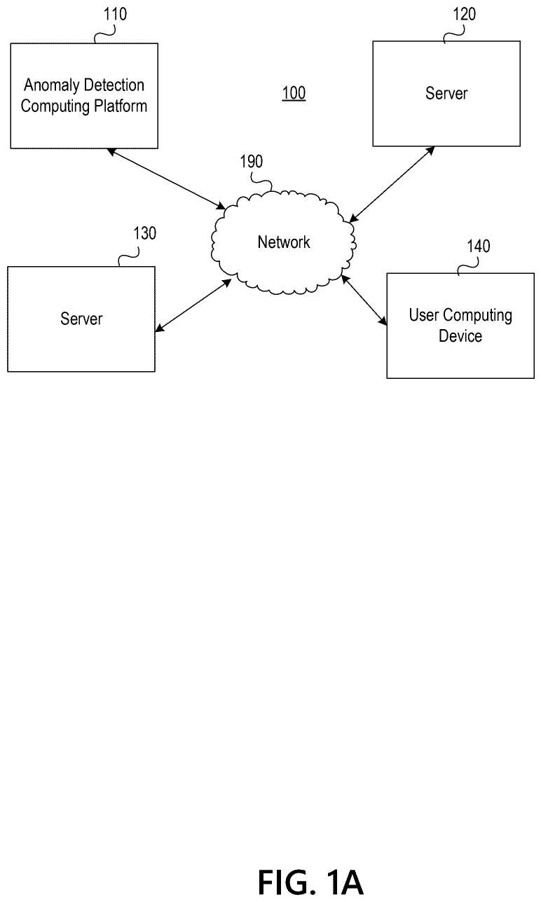

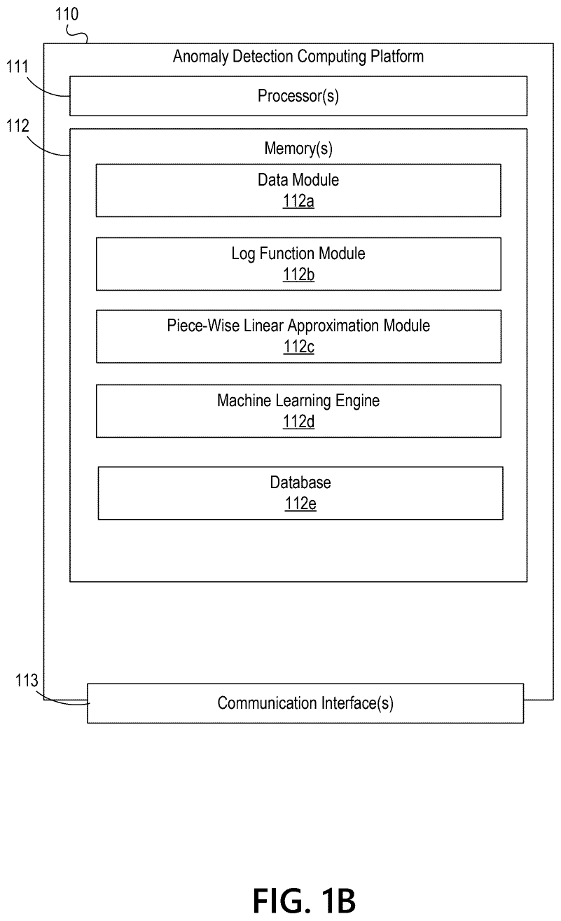

FIGS. 1A-1B depict an illustrative computing environment and devices for implementing improved time series anomaly detection functions in accordance with one or more aspects described herein. Referring to FIG. 1A, computing environment 100 may include one or more computing devices and/or other computing systems. For example, computing environment 100 may include anomaly detection computing platform 110, a first server 120, a second server 130, and user computing device 140.

Although two servers 120, 130 and one user computing device 140 are shown, any number of systems or devices may be used without departing from the invention.

Anomaly detection computing platform 110 may be configured to perform intelligent, dynamic, anomaly detection in time series data. For instance, anomaly detection computing platform 110 may receive time series data and analyze the data to identify a logarithmic factor corresponding to the data. The logarithmic factor may correspond to more recent data having a greater influence or relevance to current time slot data.

In some examples, the anomaly detection computing platform 110 may fit a piece-wise linear curve to the logarithmic factor. The piece-wise linear curve may be a two-piece curve or may include more pieces. Accordingly, the linear function may be used to generate a machine learning algorithm to identify anomalies in data. For instance, the linear function may include different weighting values to account for increased relevance in time slots closer in time to a current time slot. The generated algorithm may then be used to build a machine learning model to identify anomalies in data. In some examples, the two-piece linear curve may comprise a linear approximation of the logarithmic curve and may include an inflection point (e.g., an inflection point between each piece of the two-piece linear curve). In some examples, the machine learning model may be generated or built based on the algorithm associated with the two-piece linear approximation and data analyzed to predict current or future data may be truncated at a time just prior to the inflection point. Accordingly, this may add greater weight to the time series data closer in time to a current time, which has been shown to have increased relevance in making predictions.

Server 120 and/or server 130 may be or include one or more computer components (e.g., servers, server blades, memory, processors, or the like) and may send and receive data from a plurality of sources. In some examples, server 120 and/or server 130 may be proxy servers associated with an enterprise organization implementing the anomaly detection computing platform 110.

User computing device 140 may be or include one or more computing devices, such as a laptop computer, desktop computer, smartphone, mobile device, wearable device, or the like and may be configured to communicate with anomaly detection computing platform 110 to review or analyze data, receive and display notifications, modify one or more settings associated with anomaly detection computing platform 110, and the like.

As mentioned above, computing environment 100 also may include one or more networks, which may interconnect one or more of anomaly detection computing platform 110, first server 120, second server 130, and/or user computing device 140. For example, computing environment 100 may include network 190. Network 190 may include one or more sub-networks (e.g., Local Area Networks (LANs), Wide Area Networks (WANs), or the like). Network 190 may interconnect one or more computing devices. For example, of anomaly detection computing platform 110, first server 120, second server 130, and/or user computing device 140 may be connected via network 190.

Referring to FIG. 1B, anomaly detection computing platform 110 may include one or more processors 111, memory 112, and communication interface 113. A data bus may interconnect processor(s) 111, memory 112, and communication interface 113. Communication interface 113 may be a network interface configured to support communication between anomaly detection computing platform 110 and one or more networks (e.g., network 190, or the like). Memory 112 may include one or more program modules having instructions that when executed by processor(s) 111 anomaly detection computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of anomaly detection computing platform 110 and/or by different computing devices that may form and/or otherwise make up anomaly detection computing platform 110.

For example, memory 112 may have, store and/or include data module 112a. Data module 112a may store instructions and/or data that may cause or enable the anomaly detection computing platform 110 to receive data from one or more servers, such as one or more proxy servers. The data may be time-series data and may be analyzed to predict current and/or future values in a time series. In conventional arrangements, the data received would be analyzed to a predetermined starting time before a current time (e.g., based on an amount of data, limitations of computing resources, or the like). However, analyzing that volume of data requires vast computing resources that might not be able to provide a requested prediction before the future time occurs (e.g., it may take longer to process the data to generate the prediction than time available before the time of the requested prediction). Accordingly, the arrangement described herein limit the amount of data based on recency in order to simplify processing, reduce the volume of data processed and to enable prediction of values.

Anomaly detection computing platform 110 may further have, store and/or include log function module 112b. Log function module 112b may store instructions and/or data that may cause or enable the anomaly detection computing platform 110 to analyze the received data using a logarithmic function. For instance, a logarithmic transformation may be performed by taking a logarithm of each point in the dataset. The logarithmic transformation may indicate that data closer in time to a current time may have increased influence or relevance in making predictions.

Anomaly detection computing platform 110 may further have, store and/or include piece-wise linear approximation module 112c. Piece-wise linear approximation module 112c may store instructions and/or data that may cause or enable the anomaly detection computing platform 110 to fit a linear curve to approximate the logarithmic curve generate by analyzing the data. In some examples, the linear curve may be a two-piece linear curve having two linear pieces, each with a constant slope, and meeting at an inflection point in the logarithmic curve. In some examples, the linear curve may be used to generate an algorithm upon which a machine learning model may be based. The machine learning model may be used to predict data values or points in the time-series data. In some examples, received data may be analyzed using the machine learning model. However, in some examples, analysis of the data may stop with a data point immediately prior to the inflection point. Accordingly, older data beyond that point might not be analyzed or considered, thereby weighting more recent data that is likely more relevant.

Anomaly detection computing platform 110 may further have, store and/or include machine learning engine 112d. Machine learning engine 112d may store instructions and/or data that may cause or enable the anomaly detection computing platform 110 to create, build, train, execute, update, validate and/or refine a machine learning model. As discussed, the machine learning model may execute a machine learning algorithm based on the two-piece linear curve fit to the logarithmic curve of the data. By using the linear curve, the algorithm may be simpler which may improve processing time. Further, by truncating the data at a data point just prior to the inflection point in the logarithmic curve (e.g., where the two pieces of the linear approximations meet), smaller volumes of data may be processed in order to ensure the model is built and executed in time to predict the desired data points.

The generated model may be a time series model used to analyze data to predict future values, anomalies, and the like, in received server data. The generated model may be built and trained using, for instance, historical data. In some examples, training the model may be performed using supervised and/or unsupervised data. In some arrangements, labeled data indicating anomalies or the like may be used to train the model. After building and training the model based on the identified algorithm, received server data may be input to the model for analysis. The model may be executed and one or more future values or anomalies may be predicted.

Anomaly detection computing platform 110 may further have, store and/or include database 112e. Database 112e may store proxy server data, previously identified anomalies, algorithms, and/or other data to perform the functions of the anomaly detection computing platform 110.

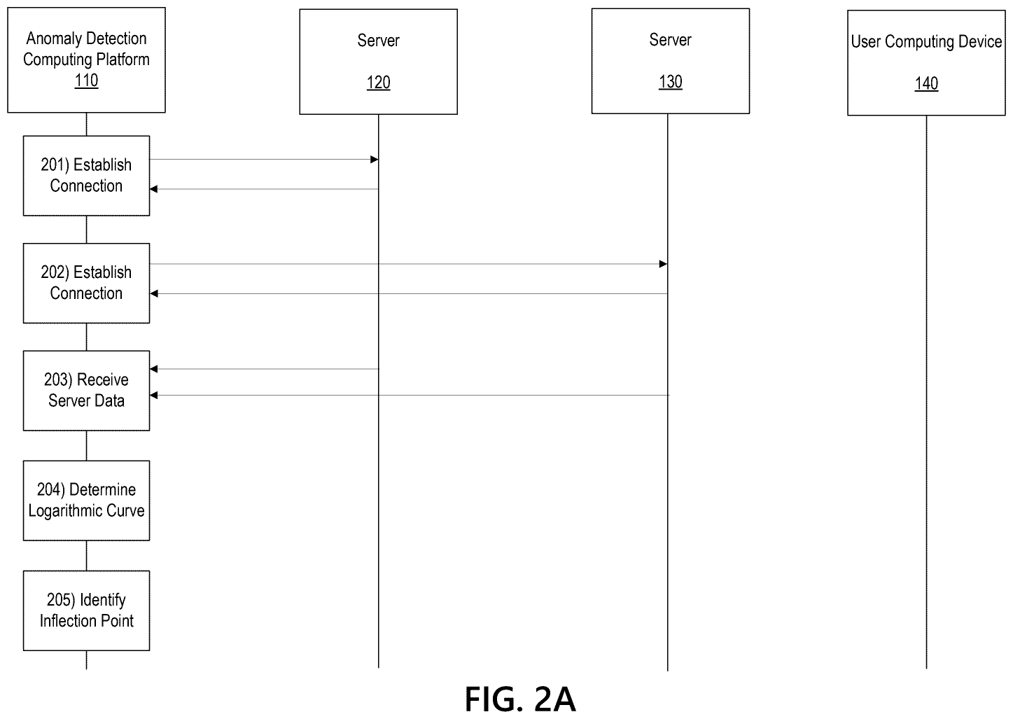

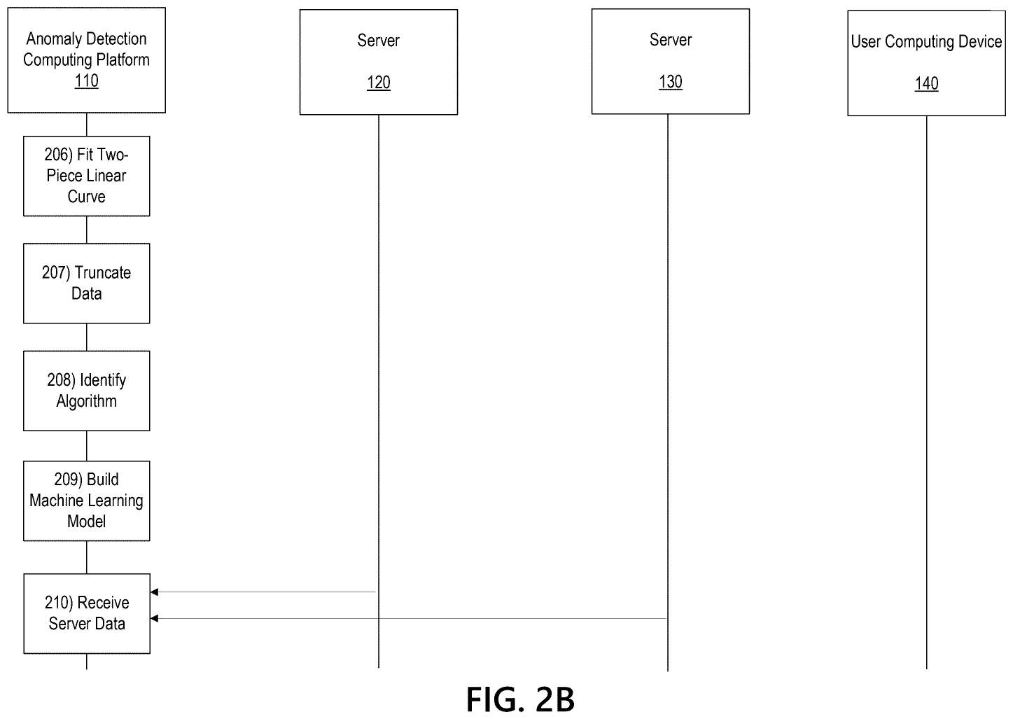

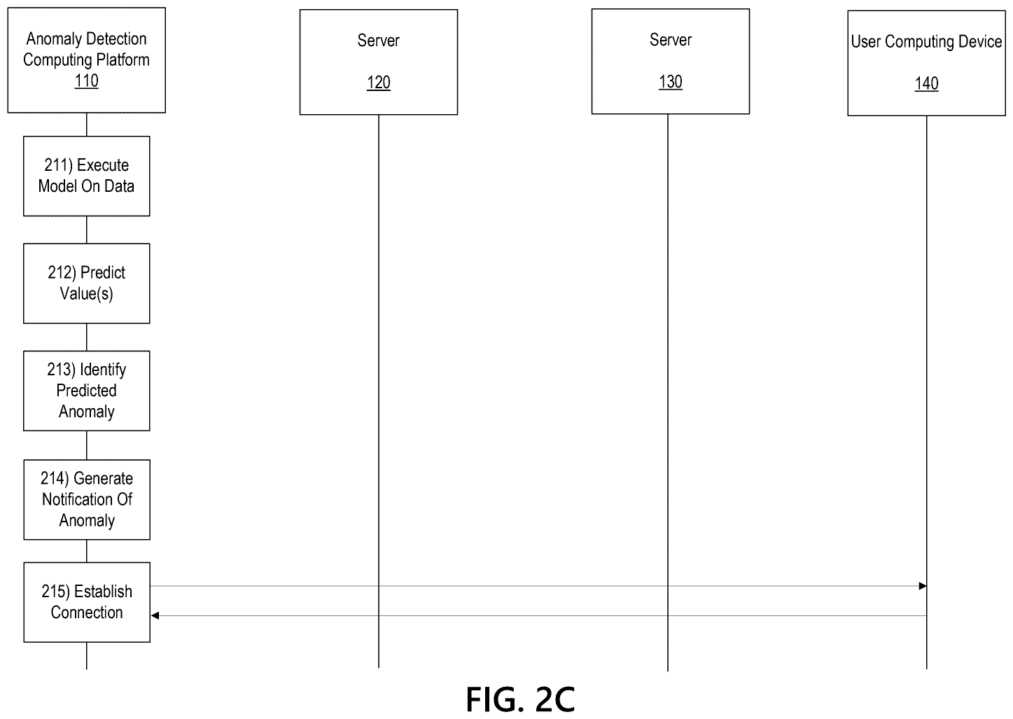

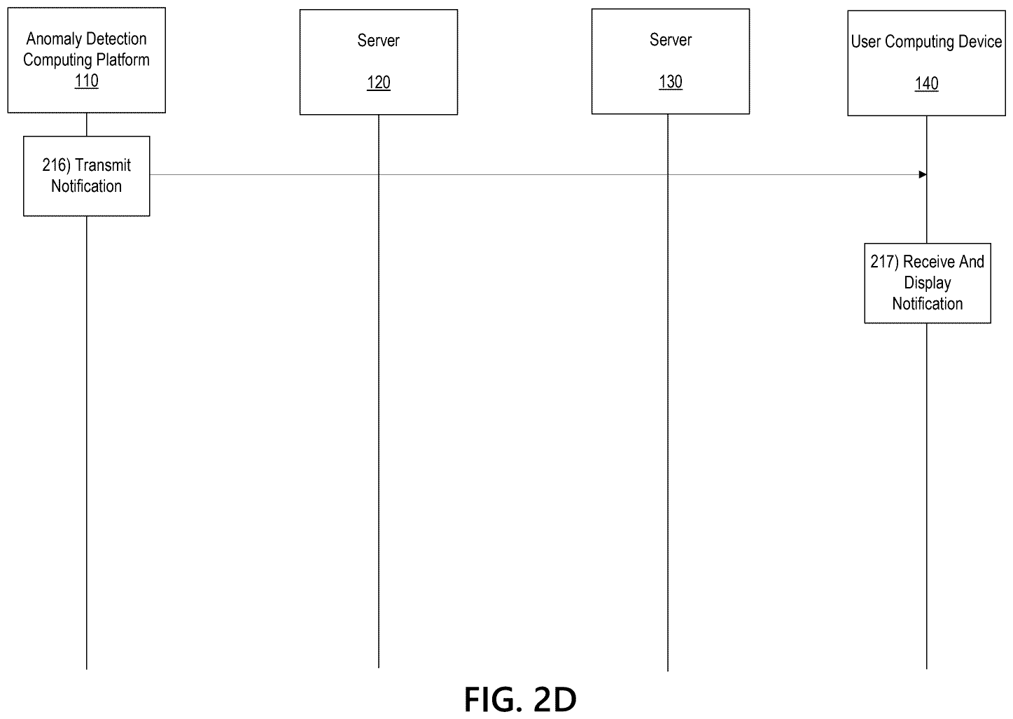

FIGS. 2A-2D depict one example illustrative event sequence for time series anomaly detection in accordance with one or more aspects described herein. The events shown in the illustrative event sequence are merely one example sequence and additional events may be added, or events may be omitted, without departing from the invention. Further, one or more processes discussed with respect to FIGS. 2A-2D may be performed in real-time or near real-time.

With reference to FIG. 2A, anomaly detection computing platform 110 may establish connections with one or more servers, such as one or more proxy servers, to analyze server data in order to predict values and/or predict/identify anomalies. Accordingly, at step 201, anomaly detection computing platform 110 may establish a wireless data connection with server 120. For instance, anomaly detection computing platform 110 may establish a first wireless connection with server 120. Upon establishing the first wireless connection, a communication session may be initiated between anomaly detection computing platform 110 and server 120.

At step 202, anomaly detection computing platform 110 may establish a wireless data connection with server 130. For instance, anomaly detection computing platform 110 may establish a second wireless connection with server 130. Upon establishing the second wireless connection, a communication session may be initiated between anomaly detection computing platform 110 and server 130.

At step 203, anomaly detection computing platform 110 may receive server data from the one or more servers. For instance, anomaly detection computing platform 110 may receive server data from server 120 and/or server 130.

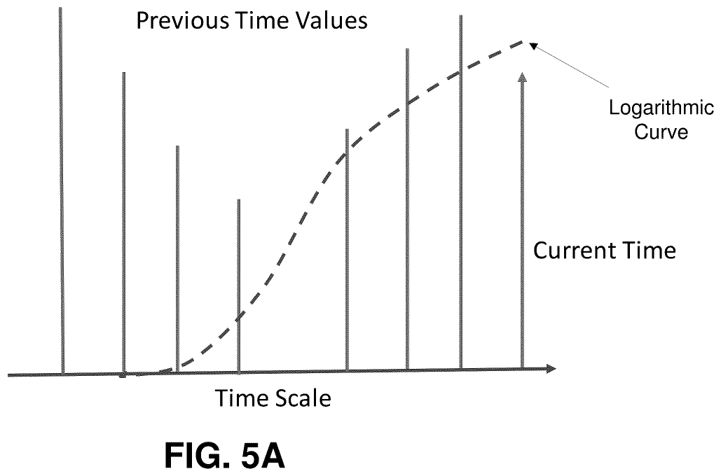

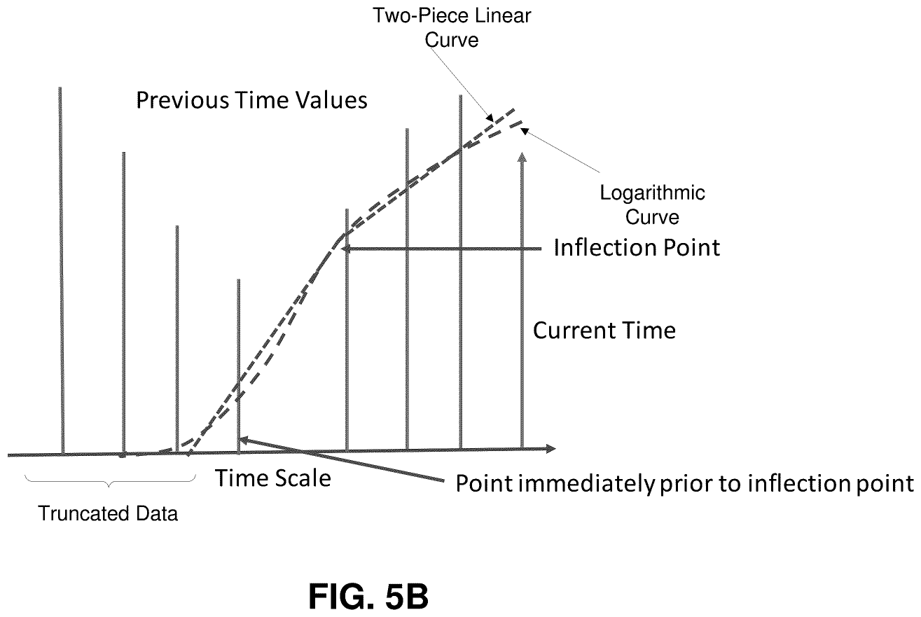

At step 204, anomaly detection computing platform 110 may generate a logarithmic curve or function corresponding to the received server data. For instance, the server data may include time series data that may be plotted and a logarithmic curve may be fitted to the data. FIG. 5A illustrates one example logarithmic curve fit to time series data.

At step 205, anomaly detection computing platform 110 may identify an inflection point in the logarithmic curve.

With reference to FIG. 2B, at step 206, anomaly detection computing platform 110 may fit a linear curve to the logarithmic curve generated. In some examples, the linear curve may be a two-piece linear curve with each piece ending at the identified inflection point in the logarithmic curve. FIG. 5B illustrates one example two-piece linear curve fit to the logarithmic curve.

At step 207, based on the two-piece linear curve, anomaly detection computing platform 110 may truncate the data for analysis or training. For instance, rather than processing all received data or all data for a time period, the data for analysis or training may be truncated at a point immediately prior to the inflection point (e.g., the point at which each piece of the two-piece linear curve ends). This may reduce the computing resources and time to build a machine learning model, analyze data, and the like.

At step 208, anomaly detection computing platform 110 may determine an algorithm associated with the two-piece linear curve. For instance, rather than building a model including an algorithm based on the logarithmic function determined from the data, which may require intensive computing resources and time, an algorithm corresponding to the two-piece linear approximation may be generated or identified.

At step 209, anomaly detection computing platform 110 may build or generate a machine learning model based on the algorithm associated with the linear approximation. In some examples, the model may be trained using the truncated data received from the one or more servers.

At step 210, anomaly detection computing platform 110 may receive additional server data from server 120, server 130, or the like.

With reference to FIG. 2C, at step 211, anomaly detection computing platform 110 may input the received server data to the model and may execute the model to predict one or more values, anomalies, or the like. Based on the algorithm executed by the machine learning model, the received server data may be truncated to reduce computing resources and time to generate the one or more predictions.

At step 212, the anomaly detection computing platform 110 may output, by the machine learning model, one or more predicted values. The predicted values may be for a current time and/or a future time in the time series data.

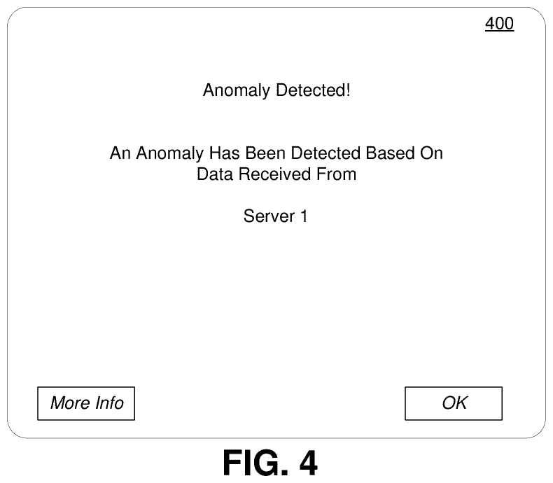

At step 213, the anomaly detection computing platform 110 may evaluate the predicted values to determine whether the predicted values constitute anomalies (e.g., values or data points outside of expected values). If so, at step 214, an anomaly detection notification may be generated by the anomaly detection computing platform 110. FIG. 4 illustrates one example anomaly detection notification 400 that may be generated. The notification 400 may include identification of a server associated with the anomaly and may include options to obtain more information.

At step 215, anomaly detection computing platform may establish a wireless data connection with user computing device 140. For instance, anomaly detection computing platform 110 may establish a third wireless connection with user computing device 140. Upon establishing the third wireless connection, a communication session may be initiated between anomaly detection computing platform 110 and user computing device 140.

With reference to FIG. 2D, at step 216, anomaly detection computing platform 110 may transmit or send the notification to the user computing device 140 during the communication session initiated upon establishing the third wireless connection. In some examples, transmitting or sending the notification may cause the user computing device 140 to display the notification on a display of the user computing device 140.

At step 217, user computing device 140 may receive and display the notification.

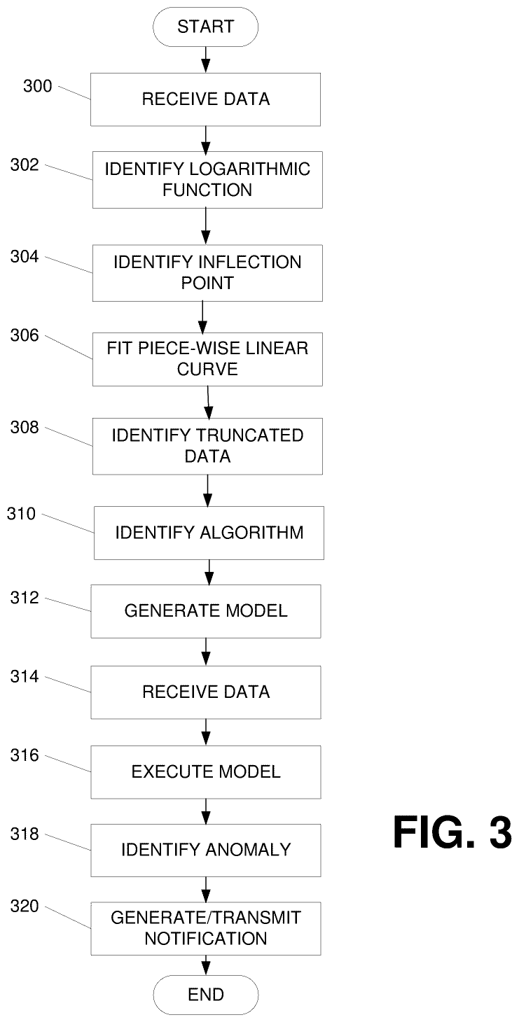

FIG. 3 is a flow chart illustrating one example method of improved time series anomaly detection in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, anomaly detection computing platform 110 may receive data from a plurality of servers. In some examples, the servers may be proxy servers and the data may include time series data.

At step 302, the anomaly detection computing platform 110 may analyze the data to determine a logarithmic function or curve corresponding to the server data. For instance, a logarithmic transformation may be performed by taking a logarithm of each point in the dataset. The logarithmic transformation may indicate that data closer in time to a current time may have increased influence or relevance in making predictions.

At step 304, anomaly detection computing platform 110 may identify an inflection point in the logarithmic curve. For instance, anomaly detection computing platform 110 may identify a point at which the function or curve changes from convex to concave, or vice versa.

At step 306, based on the logarithmic function and the identified inflection point, a piece-wise linear curve may be fit to the logarithmic function. The piece-wise linear curve may include two pieces fit to the logarithmic function or may include more. In some examples, the piece-wise linear curve may be a two-piece linear curve with an end of each piece being located at or near the identified inflection point.

At step 308, anomaly detection computing platform 110 may truncate the server data based on the two-piece linear curve. For instance, the server data may be truncated at a point immediately prior to the inflection point. In some examples, data from times earlier than the point immediately before the inflection point may be discarded.

At step 310, based on the two-piece linear curve, anomaly detection computing platform 110 may identify a machine learning algorithm for predicting or identifying values and/or anomalies in data.

At step 312, anomaly detection computing platform 110 may build or generate a machine learning model based on the identified algorithm. The machine learning model may be built and/or trained to receive server data and predict or identify future points in time series data and/or predict or identify one or more anomalies in the time series data. In some examples, the machine learning model may be built to apply a weighting factor to the truncated data to provide additional relevance to more recent data points.

At step 314, additional server data may be received. The additional server data may include time series data received from one or more servers of the plurality of servers (e.g., server 120, server 130, or the like).

At step 316, anomaly detection computing platform 110 may execute the machine learning model. For instance, anomaly detection computing platform 110 may receive, as inputs to the model, the additional server data received, and may execute the model to output or predict a future value in the time series data and/or identify or predict one or more anomalies in the additional server data. In some examples, executing the model may include truncating the additional server data and discarding earlier data.

At step 318, anomaly detection computing platform 110 may identify or predict an anomaly in the additional server data. For instance, anomaly detection computing platform 110 may analyze the predicted values output by the machine learning model to identify one or more anomalies.

At step 320, based on one or more identified anomalies, anomaly detection computing platform 110 may generate a notification identifying the anomaly and may transmit or send the notification to a user computing device. In some examples, transmitting or sending the notification to the user computing device may cause the user computing device to display the notification on a display of the user computing device.

As discussed herein, computing resources needed to process time series data can be numerous due to each time slot being dependent on a previous slot, and so on. This creates an exponential amount of data to process. Accordingly, aspects described herein provide for improved computing efficiency by approximating a logarithmic curve with a linear curve to identify a machine learning algorithm for use in building a machine learning model to identify or predict data values or anomalies. The arrangements described herein provide additional improvements by not considering the whole time series. Rather, the data is truncated based on the linear curve to reduce the amount of data being processed while still providing accurate predictions.

Further, time series data analysis is typically very slow due to the amount of data being processed. In some arrangements, requests for data analysis or prediction cannot be completed in time to predict a future value because the time to build and execute the model on the data is too long (e.g., the requested time for prediction will have passed by the time conventional arrangements are built). Accordingly, the arrangements described herein improve speed at which predictions can be made and anomalies detected, thereby improving processing, conserving computing resources, and providing more efficient identification of anomalies to enable faster mitigation of potential issues.

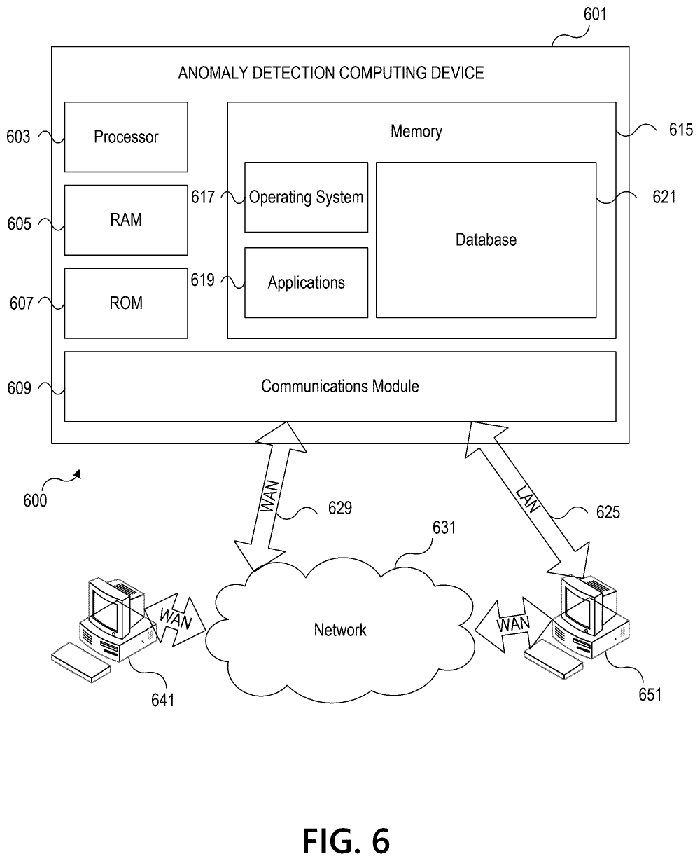

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include anomaly detection computing device 601 having processor 603 for controlling overall operation of anomaly detection computing device 601 and its associated components, including Random Access Memory (RAM) 605, Read-Only Memory (ROM) 607, communications module 609, and memory 615. Anomaly detection computing device 601 may include a variety of computer readable media. Computer readable media may be any available media that may be accessed by anomaly detection computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by anomaly detection computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on anomaly detection computing device 601. Such a processor may execute computer-executable instructions stored on a computer-readable medium.

Software may be stored within memory 615 and/or storage to provide instructions to processor 603 for enabling anomaly detection computing device 601 to perform various functions as discussed herein. For example, memory 615 may store software used by anomaly detection computing device 601, such as operating system 617, application programs 619, and associated database 621. Also, some or all of the computer executable instructions for anomaly detection computing device 601 may be embodied in hardware or firmware. Although not shown, RAM 605 may include one or more applications representing the application data stored in RAM 605 while anomaly detection computing device 601 is on and corresponding software applications (e.g., software tasks) are running on anomaly detection computing device 601.

Communications module 609 may include a microphone, keypad, touch screen, and/or stylus through which a user of anomaly detection computing device 601 may provide input, and may also include one or more of a speaker for providing audio output and a video display device for providing textual, audiovisual and/or graphical output. Computing system environment 600 may also include optical scanners (not shown).

Anomaly detection computing device 601 may operate in a networked environment supporting connections to one or more remote computing devices, such as computing devices 641 and 651. Computing devices 641 and 651 may be personal computing devices or servers that include any or all of the elements described above relative to anomaly detection computing device 601.

The network connections depicted in FIG. 6 may include Local Area Network (LAN) 625 and Wide Area Network (WAN) 629, as well as other networks. When used in a LAN networking environment, anomaly detection computing device 601 may be connected to LAN 625 through a network interface or adapter in communications module 609. When used in a WAN networking environment, anomaly detection computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive server data from a plurality of servers, wherein the server data includes time series data;
execute a logarithmic transformation on the server data to generate a logarithmic curve corresponding to the server data;
identify, in the logarithmic curve, an inflection point;
generate, based on the logarithmic curve and inflection point, a two-piece linear curve approximating the logarithmic curve;
truncate the server data based on the two-piece linear curve and the inflection point;
identify, based on the two-piece linear curve, a machine learning algorithm;
build, based on the machine learning algorithm, a machine learning model;
receive additional server data; and
execute the machine learning model, wherein executing the machine learning model includes providing, as inputs to the machine learning model, the additional server data, to output one or more predicted values.

2. The computing platform of claim 1, wherein the additional server data is time series data.

3. The computing platform of claim 1, wherein truncating the server data includes truncating the data at a point immediately prior to the inflection point.

4. The computing platform of claim 3, wherein truncating the data includes discarding data from points earlier than the point immediately prior to the inflection point.

5. The computing platform of claim 1, wherein executing the machine learning model includes truncating the additional server data and analyzing the truncated additional server data and discarding earlier data.

6. The computing platform of claim 1, further including instructions that, when executed, cause the computing platform to:
analyze the predicted values to determine whether an anomaly has been identified;
responsive to determining that an anomaly has been identified:
generate a notification including the anomaly; and
transmit the notification to a user computing device, wherein transmitting the notification to the user computing device causes the user computing device to display the notification on a display of the user computing device.

7. The computing platform of claim 1, further including instructions that when executed, cause the computing platform to:
apply a weighting factor to the truncated server data.

8. The computing platform of claim 1, wherein the plurality of servers are proxy servers.

9. A method, comprising:
receiving, by a computing platform, the computing platform having at least one processor, and memory, server data from a plurality of servers, wherein the server data includes time series data;
executing, by the at least one processor, a logarithmic transformation on the server data to generate a logarithmic curve corresponding to the server data;
identifying, by the at least one processor and in the logarithmic curve, an inflection point;
generating, by the at least one processor and based on the logarithmic curve and inflection point, a two-piece linear curve approximating the logarithmic curve;
truncating, by the at least one processor, the server data based on the two-piece linear curve and the inflection point;
identifying, by the at least one processor and based on the two-piece linear curve, a machine learning algorithm;
building, by the at least one processor and based on the machine learning algorithm, a machine learning model;
receiving, by the at least one processor, additional server data; and
executing, by the at least one processor, the machine learning model, wherein executing the machine learning model includes providing, as inputs to the machine learning model, the additional server data, to output one or more predicted values.

10. The method of claim 9, wherein the additional server data is time series data.

11. The method of claim 9, wherein truncating the server data includes truncating the data at a point immediately prior to the inflection point.

12. The method of claim 11, wherein truncating the data includes discarding data from points earlier than the point immediately prior to the inflection point.

13. The method of claim 9, wherein executing the machine learning model includes truncating the additional server data and analyzing the truncated additional server data and discarding earlier data.

14. The method of claim 9, further including:
analyzing, by the at least one processor, the predicted values to determine whether an anomaly has been identified;
responsive to determining that an anomaly has been identified:
generating, by the at least one processor, a notification including the anomaly; and
transmitting, by the at least one processor, the notification to a user computing device, wherein transmitting the notification to the user computing device causes the user computing device to display the notification on a display of the user computing device.

15. The method of claim 9, further including instructions that when executed, cause the computing platform to:
apply a weighting factor to the truncated server data.

16. The method of claim 9, wherein the plurality of servers are proxy servers.

17. One or more non-transitory computer-readable media storing instructions that, when executed by a computing platform comprising at least one processor, memory, and a communication interface, cause the computing platform to:
receive server data from a plurality of servers, wherein the server data includes time series data;
execute a logarithmic transformation on the server data to generate a logarithmic curve corresponding to the server data;
identify, in the logarithmic curve, an inflection point;
generate, based on the logarithmic curve and inflection point, a two-piece linear curve approximating the logarithmic curve;
truncate the server data based on the two-piece linear curve and the inflection point;
identify, based on the two-piece linear curve, a machine learning algorithm;
build, based on the machine learning algorithm, a machine learning model;
receive additional server data; and
execute the machine learning model, wherein executing the machine learning model includes providing, as inputs to the machine learning model, the additional server data, to output one or more predicted values.

18. The one or more non-transitory computer-readable media of claim 17, wherein the additional server data is time series data.

19. The one or more non-transitory computer-readable media of claim 17, further including instructions that, when executed, cause the computing platform to:
analyze the predicted values to determine whether an anomaly has been identified;
responsive to determining that an anomaly has been identified:
generate a notification including the anomaly; and
transmit the notification to a user computing device, wherein transmitting the notification to the user computing device causes the user computing device to display the notification on a display of the user computing device.

20. The one or more non-transitory computer-readable media of claim 17, wherein the plurality of servers are proxy servers.
